(19) United States
(12) Patent Application Publication
(10) Pub. No.: US 2009/0253285 A1
(43) Pub. Date: Oct. 8, 2009

(54) PCI CARD FIXING DEVICE

(75) Inventor: Chun-Ying YANG, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/099,260

(22) Filed: Apr. 8, 2008

(51) Int. Cl. H01R 13/62

(52) U.S. Cl. 439/312

(57) ABSTRACT

A peripheral component interconnect card (PCI card) fixing device is used to fix a PCI card in a case of a computer device. The PCI card fixing device includes a pressing member and a stopping member. One end of the pressing member is pivotally connected to the case, and the other end is pivotally connected to one end of the stopping device. The pressing member pivots in a rotation direction and presses against the PCI card, and the other end of the stopping member pivots in a rotation direction reverse to that of the pressing member and is buckled on the case, so that the pressing member may stably urge against the PCI card.

### BACKGROUND OF THE INVENTION

1. Field of Invention

The present invention relates to a fixing device and more particularly to a PCI card fixing device.

2. Related Art

Currently, computer devices are popularized electronic devices. Computer peripheral hardware devices such as peripheral component interconnect cards (PCI card) and other external hardware devices of the current computer devices available in the market, such as desktop computers, notebook computers and servers must be electrically connected to circuit boards, so as to perform default functions of the peripheral hardware devices through the communication and signal transmission between the circuit boards and the computer peripheral hardware devices.

The PCI card fixing method of a conventional server is to lock a fixing bracket onto a case of the server for the insertion of the PCI card, and the PCI card is electrically connected to a socket in a circuit board. A bent fixing piece is formed at one end of the PCI card, and a screw hole is formed in the fixing piece. The PCI card may be locked on the fixing bracket by a screw passing through the screw hole, thereby the PCI card is fixed in the computer device. However, when the PCI card is mounted or detached, a hand tool must be used to tighten or loosen screws, and a lot of time must be spent to tighten or loosen screws. Therefore, the process is too complicated, time-consuming, and inconvenient. Also, the screw when being loosened may easily drop onto the main board, which causes the circuit on the main board short and burn down.

In order to solve the problem that a hand tool must be used to tighten or loosen the screw when the PCI card is mounted or detached, Taiwan Patent No. 562164 has disclosed an embedded seat fixing mechanism, which includes an embedded seat and a fixing bar. The embedded seat is disposed on a case of a computer device, and one end of the fixing bar is pivotally connected to the case at a position adjacent to the embedded seat, so that the other end of the fixing bar pivots to be away from or get close to the embedded seat, so as to clamp and fix a fixed object leaning against the embedding seat.

In addition, U.S. Pat. No. 7,161,798 has disclosed an expansion card retention apparatus, which includes a first fixing bracket, a second bracket, and a rear panel. A plurality of expansion slots is disposed on the rear panel. The first fixing bracket may be rotatably fixed on the rear panel. The second fixing bracket is fixed on the first fixing bracket, and includes a plurality of abut portions, so as to sufficiently fix the expansion cards in the expansion slots.

Although the above two patents solve the problem caused when the PCI card is locked by screws, only one pressing element (such as the fixing bar in Taiwan Patent No. 562164 and the second fixing bracket in U.S. Pat. No. 7,161,798) is used to retain the PCI card. If the computer device shakes or is impacted by an external force, the pressing element will drop off from the PCI card easily, and cannot provide the pressing function.

### SUMMARY OF THE INVENTION

In view of the aforementioned problem, the present invention provides a PCI card fixing device, so as to solve the problem that the PCI card fixing device in the prior art has only one pressing element and is not provided with a member to stop the pressing element, which further causes that the pressing element easily gets loose under an external force and cannot provide the pressing function.

The PCI card fixing device of the present invention is used to fix a PCI card in a case of a computer and includes a pressing member and a stopping member. One end of the the pressing member is a first pivoting end, the other end is a second pivoting end, and the second pivoting end extends to form an urging portion. The first pivoting end of the pressing member is pivotally connected to the case, so that the urging portion may pivot along a first rotation direction to be displaced to an urging position to press the PCI card. One end of stopping member is a third pivoting end, and the other end is a toggle end. The third pivoting end of the stopping member is pivotally connected to the second pivoting end of the pressing member, and the toggle end may pivot along a second rotation direction reverse to the first rotation direction and is buckled on the case, so that the urging portion of the pressing member is retained at an urging position, and the PCI card may be stably mounted in the case.

The present invention has the following effects. The pressing member and the stopping member pivot in two opposite directions, such that when the stopping member is buckled with the case, the pressing member may be restrained and cannot pivot. Therefore, the pressing member may not leave the urging position under an external force, and is normally retained at the urging position to continuously press the PCI card, and thus the PCI card may be fixedly mounted on the case and will not drop off.

### BRIEF DESCRIPTION OF THE DRAWINGS

The present invention will become more fully understood from the detailed description given herein below for illustration only, and thus are not limitative of the present invention, and wherein:

FIG. 1 is a schematic exploded view of the present invention;

FIG. 2 is a schematic three-dimensional view of the present invention in a released state;

FIG. 3 is a schematic three-dimensional view of the pressing member, according to the present invention, pressing the PCI card; and

FIG. 4 is a schematic three-dimensional view of the present invention in a retaining state.

### DETAILED DESCRIPTION OF THE INVENTION

The PCI card fixing device of the present invention is used to fix a PCI card in a computer device, and the computer devices include, but not limited to, desktop computers, notebook computers, servers, and others that can be electrically connected to the PCI card. In the following detailed description of the present invention, the server is taken as a preferred embodiment of the present invention. However, the accompanied drawings are only used for reference and illustration and are not intended to limit the present invention.

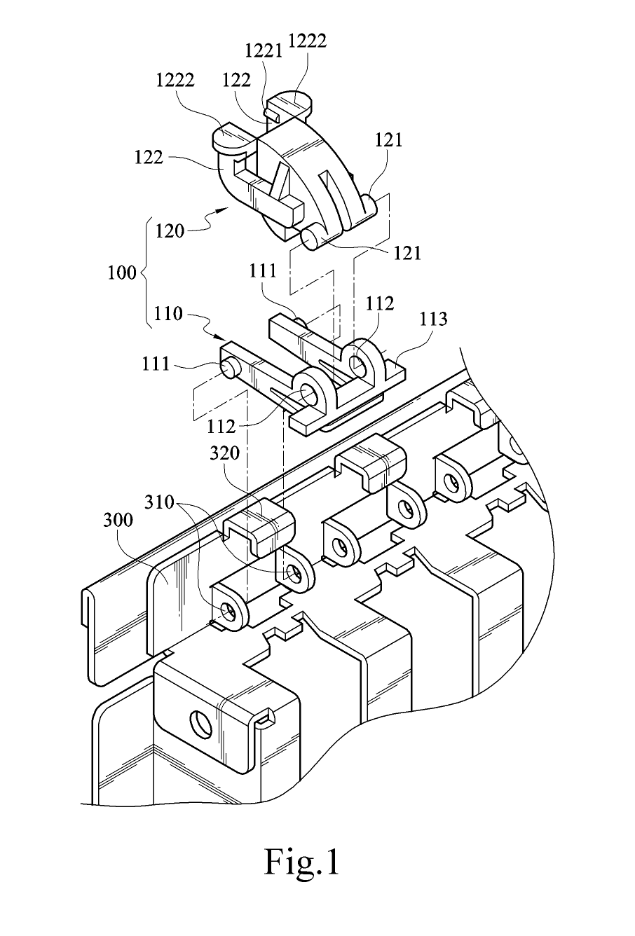

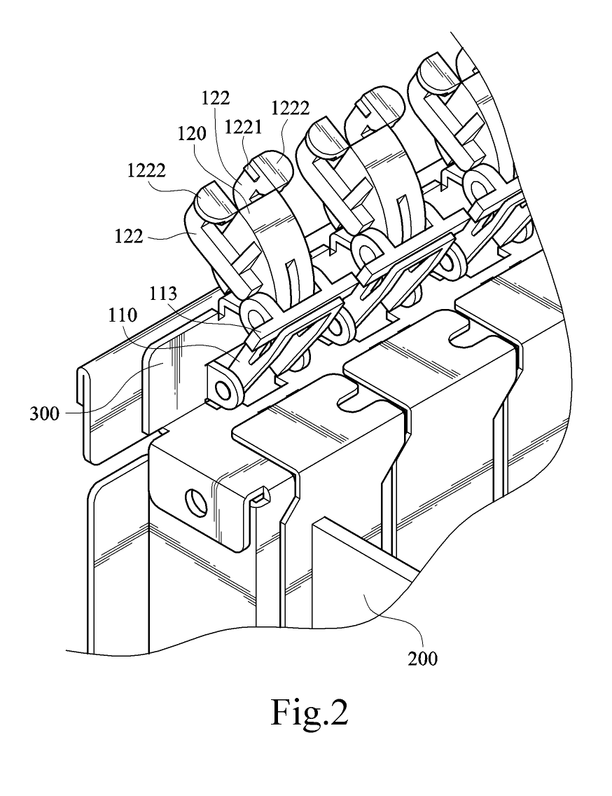

FIGS. 1 and 2 are schematic views of the present invention. The PCI card fixing device 100 of the present invention is used to fix a PCI card 200 in a case 300 of a computer device. A fixing bracket is locked on the case 300 to partition the case 300 into a plurality of accommodation regions for a plurality of PCI cards 200 to be mounted therein. In addition, the fixing bracket on the case 300 has two opposite first pivot holes 310 and a buckling piece 320.

The PCI card fixing device 100 includes a pressing member 110 and a stopping member 120. One end of the pressing member 110 is a first pivoting end, and the first pivoting end extends towards two opposite directions to form a first shaft 111 respectively. The other end of the pressing member 110 is a second pivoting end, and the second pivoting end has two opposite second pivot holes 112. The second pivoting end extends to form an urging portion 113. The urging portion 113 is of a rectangular structure, so as to provide the pressing effect in a large area. The pressing member 110 is inserted into the first pivot holes 310 of the case 300 through the first shaft 111, so that the pressing member 110 is pivotally connected to the case 300, and the urging portion 113 pivots with the first shaft 111 as an axle center relative to the case 300 along a first rotation direction.

One end of the stopping member 120 is a third pivoting end, and the third pivoting end extends towards two opposite directions to form a second pivot shaft 121 respectively. The other end of the stopping member 120 is a toggle end, and the toggle end has two opposite cantilevers 122. A buckling block 1221 raises from the inner sides of the two cantilevers 122, respectively, and an operating portion 1222 is disposed on the tops of the two cantilevers 122 of the toggle end, respectively, such that a user can grip to exert an external force on the stopping member 120. The third pivoting end is inserted into the second pivot holes 112 of the second pivoting end through the second pivot shaft 121. An included angle is formed between the second pivoting end and the third pivoting end. The third pivoting end of the stopping member 120 is pivotally connected to the second pivoting end of the pressing member 110, and the toggle end of the stopping member 120 pivots with the second pivot shaft 121 as an axle center relative to the pressing member 120 along a second rotation direction reverse to the first rotation direction.

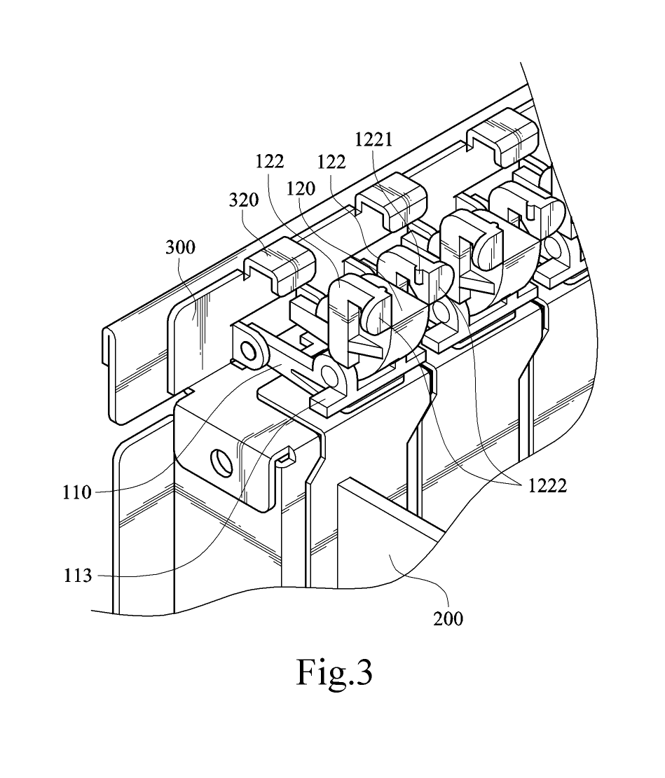

FIGS. 2 and 3 are schematic three-dimensional views. Referring to FIGS. 2 and 3, the urging portion 113 of the pressing member 110 is displaced along the first rotation direction to an urging position to press the PCI card 200, so as to fix the PCI cards 200 on the fixing bracket of the case 300. As such, the PCI card 200 is retained at a position where the PCI card 200 is electrically connected to a circuit board (not shown), such that the PCI card 200 will not drop off from the circuit board to fail performing the default functions.

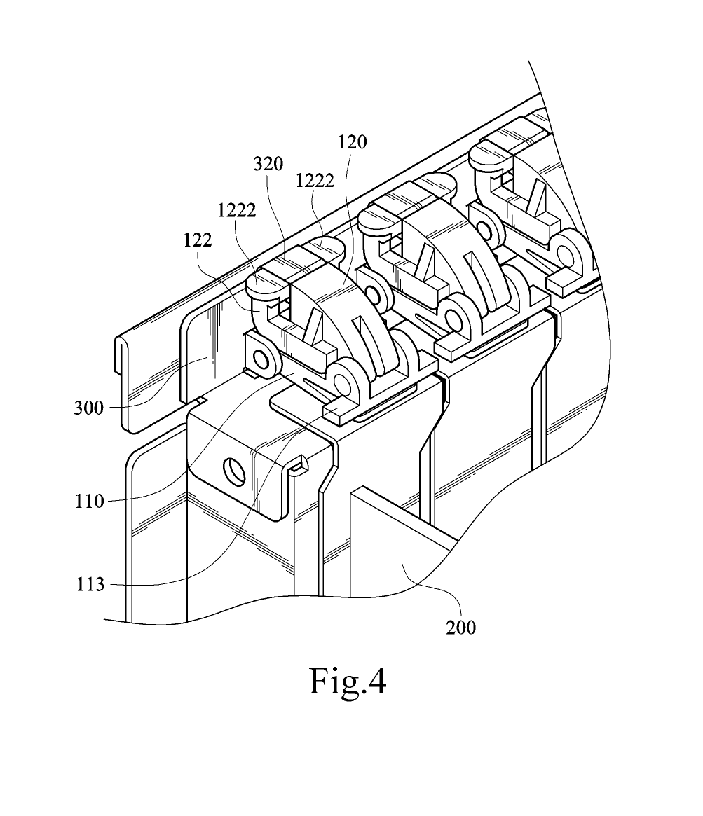

Referring to FIG. 4, when the pressing member 110 pivots to the urging position, the stopping member 120 pivotally connected to the pressing member 110 pivots along a direction (i.e., the aforementioned second rotation direction) reverse to the first rotation direction of the urging position 113 through the toggle end. The buckling block 1221 is buckled with the buckling piece 320 of the case 300, so as to fix the toggle end on the case 300. When the stopping member 120 is buckled on the case 300, the stopping member 120 pivots to get close to the pressing member 110 and is folded to an opposite position overlapped with the pressing member 110, thereby reducing the space occupied by the fixing device 100.

Since the pressing member 110 and the stopping member 120 pivot in two opposite directions, when the stopping member 120 is buckled on the case 300, a stopping force is provided to limit the pivotal rotation of the pressing member 110, so as to stably retain the pressing member 110 at the urging position to prevent the pressing member 110 from leaving the urging position under an external force to lose the function of fixing the PCI card 200.

The PCI card fixing device disclosed in the present invention uses the stopping member rotated in a direction reverse to that of the pressing member to limit the pivotal rotation of the pressing member, thereby retaining the pressing member at the urging position to fix the PCI card on the case. Furthermore, due to the stopping force generated when the stopping member is buckled with the case, the pressing member is prevented from leaving the urging position under an external force and thus the PCI card is stably mounted on the case and will not drop off from the case.

What is claimed is:

1. A PCI card fixing device, for fixing a PCI card in a case of a computer device, comprising:
a pressing member, wherein one end of the pressing member is a first pivoting end, the other end is a second pivoting end, the second pivoting end extends to form an urging portion, the first pivoting end is pivotally connected to the case, and the urging position pivots in a first rotation direction to be displaced to an urging position and press the PCI card; and
a stopping member, wherein one end of the stopping member is a third pivoting end, the other end is a toggle end, the third pivoting end is pivotally connected to the second pivoting end, the toggle end pivots along a second rotation direction reverse to the first rotation direction and is buckled on the case, so that the urging portion is retained at the urging position.

2. The PCI card fixing device according to claim 1, wherein an included angle is formed between the second pivoting end and the third pivoting end.

3. The PCI card fixing device according to claim 1, wherein the first pivoting end has two opposite first pivot shafts, the case has two opposite first pivot holes, the first shafts are inserted into the first pivot holes, so that the pressing member is pivotally connected to the case.

4. The PCI card fixing device according to claim 1, wherein the second pivoting end has two opposite second pivot holes, the third pivoting end has two opposite second pivot shafts, the second pivot shafts are inserted into the second pivot holes, so that the stopping member is pivotally connected to the pressing member.

5. The PCI card fixing device according to claim 1, wherein the toggle end has two opposite cantilevers, the two cantilevers respectively have a buckling block, the case has a buckling piece, and the two buckling blocks are engaged with the buckling piece so as to fix the toggle end to the case.

6. The PCI card fixing device according to claim 1, wherein the toggle end further comprises at least one operating portion.
